(19) United States
(12) Patent Application Publication
(10) Pub. No.: US 2026/0168528 A1
(43) Pub. Date: Jun. 18, 2026

(54) INTEGRALLY FORMED ELASTIC SNAP HOOK MADE FROM SYNTHETIC RESIN

(71) Applicants: William Lee, Taipei (TW); Leon Sports Ltd., Wuxi (CN)

(72) Inventor: William Lee, Taipei (TW)

(21) Appl. No.: 19/209,829

(22) Filed: May 16, 2025

(30) Foreign Application Priority Data
Dec. 16, 2024 (CN) 2024231094470

(51) Int. Cl. F16B 45/02

(52) U.S. Cl. CPC F16B 45/023; F16B 45/024; F16B 45/036

(57) ABSTRACT

An integrally formed elastic snap hook made from synthetic resin and including a hook body and a moveable member is provided. A stopping portion is arranged at a middle area of the moveable member for stopping fingers between the stopping portion and a base of the hook body. In a closed state, the finger is pressing between the stopping portion and the base and then applying a force to the stopping portion so that the moveable member is elastically moved toward a looped area of the elastic snap hook by using the base as the pivot. Thus the elastic snap hook is in a released state in which the finger is stopped by the stopping portion and unable to enter a hook-in space of the elastic snap hook. Thereby the design prevents a bad user experience in the product and further increases market competitiveness of the product.

### CROSS-REFERENCE TO RELATED APPLICATIONS

This non-provisional application claims priority under 35 U.S.C. § 119(a) on Patent Application No(s). 2024231094470 filed in China on Dec. 16, 2024, the entire contents of which are hereby incorporated by reference.

### BACKGROUND OF THE INVENTION

The present invention relates to a snap hook, especially to an integrally formed elastic snap hook made from synthetic resin.

Refer to FIG. 14, FIG. 15, and FIG. 16, an integrally-formed elastic snap hook 3 made of synthetic resin available now is provided. Refer to FIG. 14, the elastic snap hook 3 includes a hook body 3a and a moveable member 3b integrally formed with each other. A closed area 3c is formed between the hook body 3a and the moveable member 3b. The hook body 3a is provided with a hook portion 3e extended from a base 3d of the hook body 3a. Based on the base 3d, the elastic snap hook 3 made of synthetic resin has a front end 3f and a rear end 3g. The rear end 3g is an end with the base 3d while the front end 3f is opposite to the rear end 3g, extending from the base 3d toward a direction away from the rear end 3g. The moveable member 3b is provided with a front-end outer-side close surface 3h for being matched with a front-end inner-side close surface 3j of a curved portion 3i of the hook body 3a. The front-end outer-side close surface 3h is extending to reach the front-end inner-side close surface 3j partially. The moveable member 3b is elastically moved with respect to the base 3d by using the base 3d as a pivot. Thus the moveable member 3b can be moved toward the closed area 3c or moved away from the closed area 3c and turned back to its original position. When a user's finger 2 is applying a force to the moveable member 3b (as the arrow A in FIG. 15 indicates), the moveable member 3b is moved toward the closed area 3c and the front-end outer-side close surface 3h is away from the front-end inner-side close surface 3j to be in a released state. In the released state, a hook-in space 3k is formed between the front-end outer-side close surface 3h and the front-end inner-side close surface 3j. When the force applied to the moveable member 3b is released, the front-end outer-side close surface 3h is moved elastically from the inside to the outside (as the arrow B in FIG. 16 indicates) and turned back to its original position to be matched with the front-end inner-side close surface 3j and in a closed state.

However, while the elastic snap hook 3 is released from the closed state, the user' finger 2 is easy to slide from the moveable member 3b to the hook-in space 3k and getting clipped. Thereby the operation is not convenient and the user has bad feelings while experiencing the product. Moreover, the hook-in space 3k is forced to be reduced because the user's finger 2 enters the hook-in space 3k. Thus the elastic snap hook 3 is difficult to be hooked on other objects due to the reduced hook-in space 3k. While removing the elastic snap hook 3 from other objects, the elastic snap hook 3 is also difficult to be taken down.

Thus there is room for improvement and there is a need to provide an integrally formed elastic snap hook made from synthetic resin and able to prevent user's fingers from sliding into the hook-in space of the elastic snap hook.

### SUMMARY OF THE INVENTION

Therefore, it is a primary object of the present invention to provide an integrally formed elastic snap hook made from synthetic resin and composed of a hook body and a moveable member integrally formed with each other. A stopping portion is arranged at a middle area of the moveable member for stopping fingers at a position between the stopping portion and a base of the hook body. While in a closed state, the finger is firstly pressing on a position between the stopping portion and the base, without being moved toward the front end. At the moment, the finger is applying a force to the stopping portion so that the moveable member is elastically moved toward a looped area of the elastic snap hook by using the base as the pivot. Thus the elastic snap hook is in a released state. While in the released state, the finger is stopped by the stopping portion and unable to enter a hook-in space of the elastic snap hook. Thereby the user will not experience negative emotions while using product and this improves the market competitiveness of the product.

In order to achieve above objects, an integrally formed elastic snap hook made from synthetic resin according to the present invention is provided with a hook body and a moveable member integrally formed with each other. A looped area is formed between the hook body and the moveable member. The hook body consists of a base and a hook portion extended from the base. Based on the base, the elastic snap hook is provided with a front end and a rear end. One end of the base is located at the rear end and the other end of the base is the front end which is extending toward a direction opposite to the rear end. The moveable member is provided with a front-end outer-side close surface for being matched with a front-end inner-side close surface of a curved portion of the hook body. The front-end outer-side close surface is extending to reach the front-end inner-side close surface. The moveable member is elastically moved with respect to the base by using the base as a pivot. Thus the moveable member can be moved toward the looped area or away from the looped area and turned back to its original position. When a finger is applying a force to the moveable member and the moveable member is moved toward the looped area, the front-end outer-side close surface is away from the front-end inner-side close surface to be in a released state. In the released state, a hook-in space is formed between the front-end outer-side close surface and the front-end inner-side close surface. When the force applied to the moveable member is released, the front-end outer-side close surface is moved elastically from the inside to the outside and turned back to its original position to be matched with the front-end inner-side close surface and in a closed state. A stopping portion is disposed on a middle area of the moveable member for stopping the finger at a position between the stopping portion and the base. While in the closed state, the finger is firstly pressing on a position between the stopping portion and the base, without being moved toward the front end. At the moment, the finger is applying a force to the stopping portion so that the moveable member is elastically moved toward the looped area by using the base as the pivot to be in a released state. While in the released state, the finger is stopped by the stopping portion and unable to enter the hook-in space.

Preferably, the stopping portion is a curved protrusion projecting away from the looped area and a sliding ramp is arranged between the curved protrusion and the moveable member.

Preferably, the stopping portion is a curved concave part concave toward the looped area. The finger is able to move from the moveable member into the curved concave part.

Preferably, the stopping portion is a bead-like part projecting away from the looped area. The finger is further able to press the bead-like part from the moveable member.

Preferably, the stopping portion is further provided with a plurality of anti-slipping slots.

Preferably, a rotary ring is disposed on the base.

Preferably, the base is further provided with a through hole and a metal ring is mounted to the through hole.

Preferably, the front-end inner-side close surface is further provided with a first closed portion. The front-end outer-side close surface is further provided with a second closed portion. The first closed portion and the second closed portion are step-like parts/teeth able to be engaged with and closed by each other.

### BRIEF DESCRIPTION OF THE DRAWINGS

FIG. 1 is a perspective view of a first embodiment (in which a stopping portion is a curved protrusion) of an elastic snap hook according to the present invention;

FIG. 2 is a side view of a first embodiment (in which a stopping portion is a curved protrusion) of an elastic snap hook according to the present invention;

FIG. 3 is a schematic drawing showing a moveable member moved toward a looped area of the embodiment in FIG. 2 according to the present invention;

FIG. 4 is a schematic drawing showing the moveable member elastically moved away from the looped area and turned back to its original position of the embodiment in FIG. 3 according to the present invention;

FIG. 5 is a side view showing a base provided with a rotary ring of an embodiment according to the present invention;

FIG. 6 is a side view showing a base provided with a metal ring of an embodiment according to the present invention;

FIG. 7 is a front view showing a base provided with a metal ring of an embodiment according to the present invention;

FIG. 8 is a perspective view of a second embodiment (in which a stopping portion is a bead-like part) of an elastic snap hook according to the present invention;

FIG. 9 is a front view of a second embodiment (in which a stopping portion is a bead-like part) of an elastic snap hook according to the present invention;

FIG. 10 is a side view of a second embodiment (in which a stopping portion is a bead-like part) with a moveable member moved toward a looped area according to the present invention;

FIG. 11 is a side view of an embodiment which includes a stopping portion provided with a plurality of anti-slipping slots according to the present invention;

FIG. 12 is a side view of a third embodiment (in which a stopping portion is a curved concave part) of an elastic snap hook according to the present invention;

FIG. 13 is a side view of a third embodiment (in which a stopping portion is a curved concave part) with a moveable member moved toward a looped area according to the present invention;

FIG. 14 is a schematic drawing showing a side view of an elastic snap hook available now;

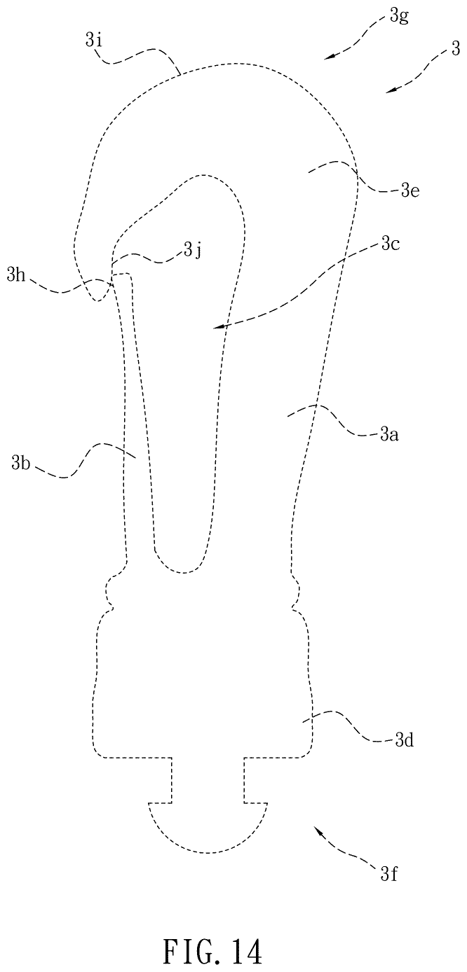

FIG. 15 is a schematic drawing showing a moveable member moved toward a looped area of the elastic snap hook in FIG. 14 according to the present invention;

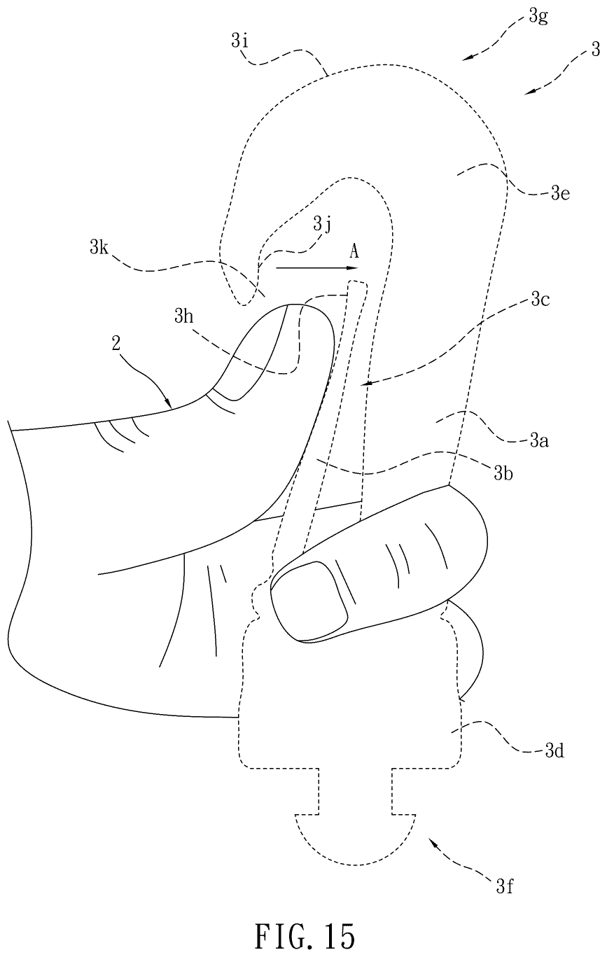

FIG. 16 is a schematic drawing showing the moveable member elastically moved away from the looped area and turned back to its original position of the elastic snap hook in FIG. 15 according to the present invention.

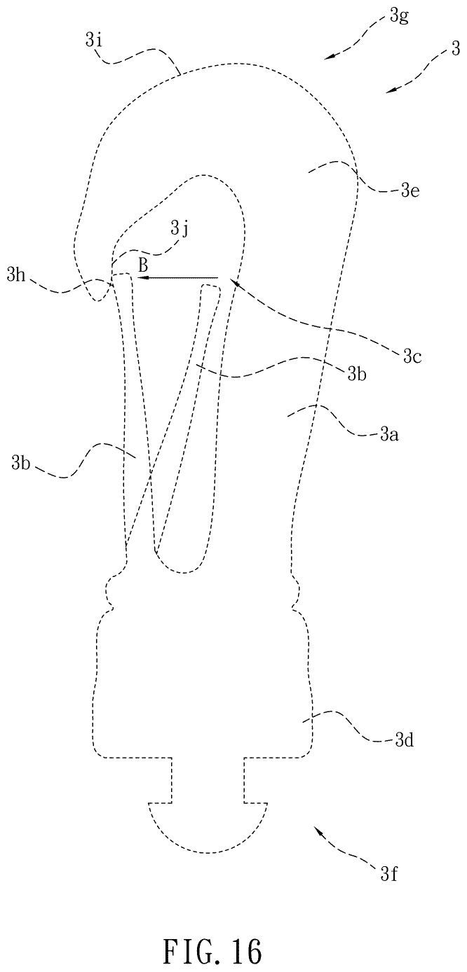

### DETAILED DESCRIPTION OF THE PREFERRED EMBODIMENT

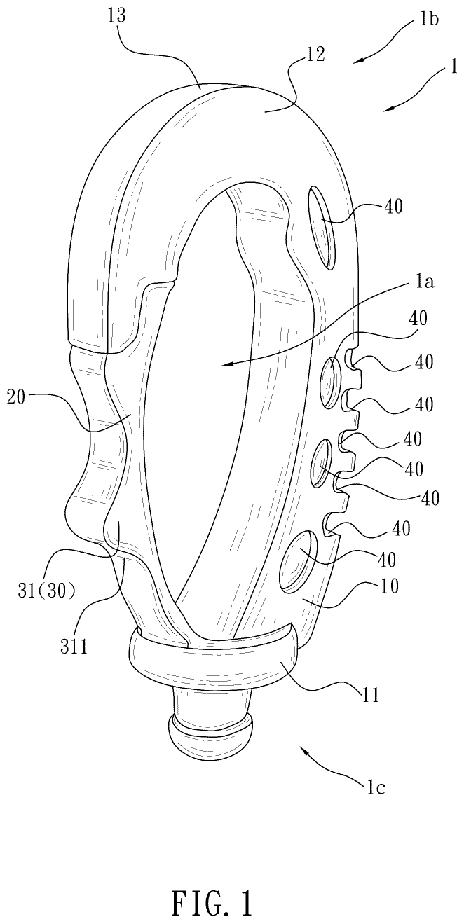

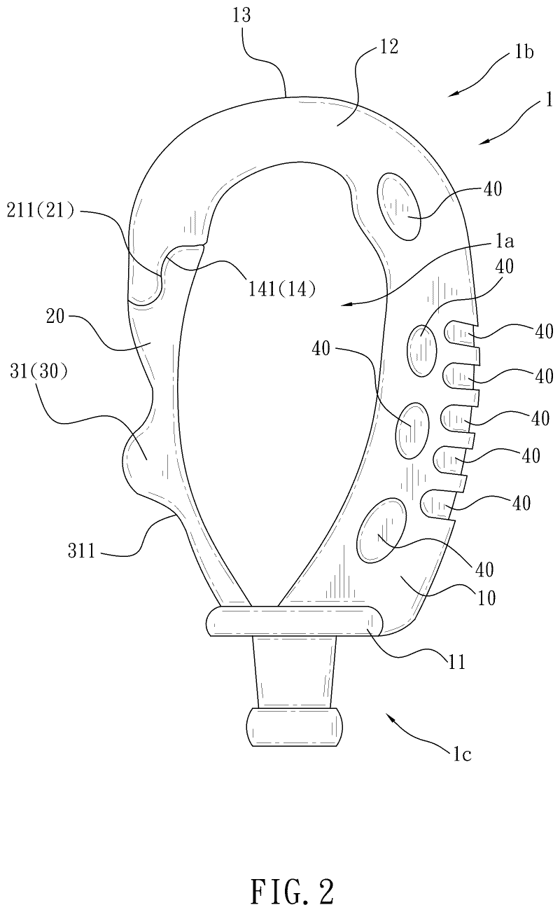

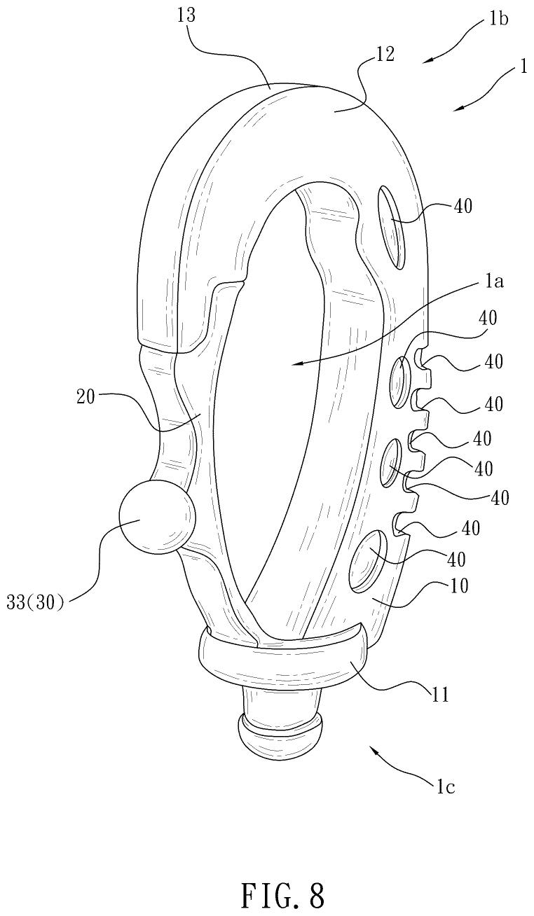

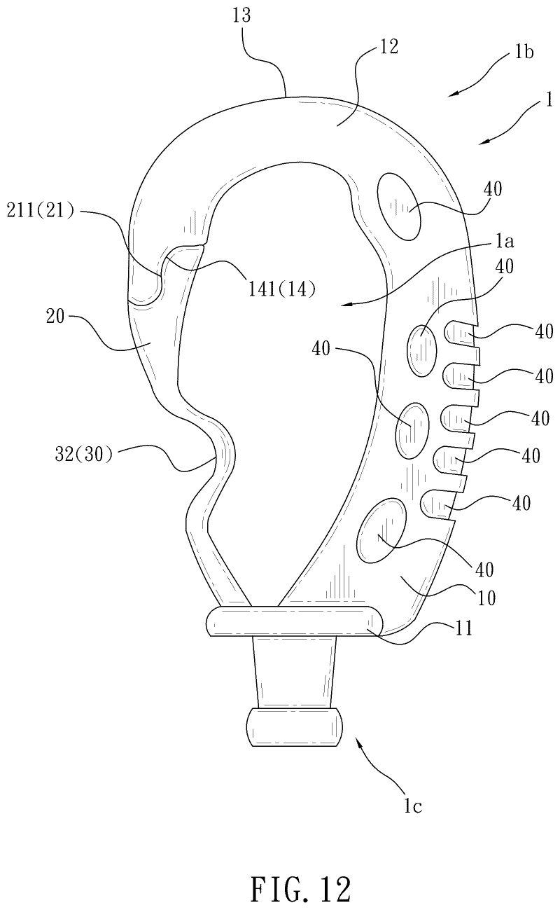

Refer to FIG. 1, FIG. 2, FIG. 8, and FIG. 12, an integrally formed elastic snap hook 1 made of synthetic resin according to the present invention includes a hook body 10 and a moveable member 20 integrally formed with each other. A looped area 1a is formed between the hook body 10 and the moveable member 20. Compared with common metal materials, the synthetic resin is cheaper and this helps cost reduction in manufacturing.

As shown in FIG. 1 and FIG. 2, the hook body 10 consists of a base 11 and a hook portion 12 extended from the base 12. Based on the base 11, the elastic snap hook 1 is provided with a front end 1b and a rear end 1c. One end of the base 11 is located at the rear end 1c and the other end of the base 11 is the front end 1b which is extending toward a direction opposite to the rear end 1c, as shown in FIG. 1 and FIG. 2.

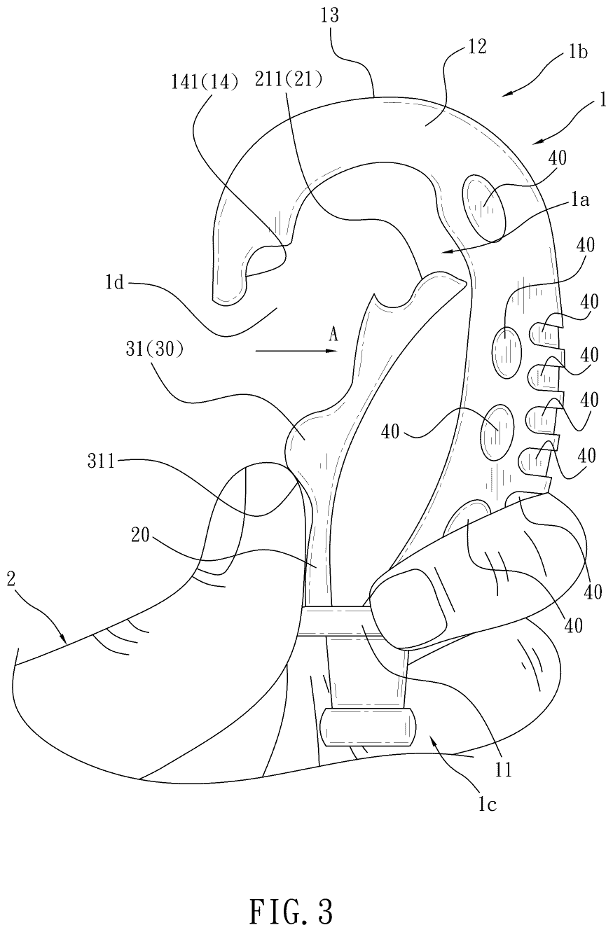

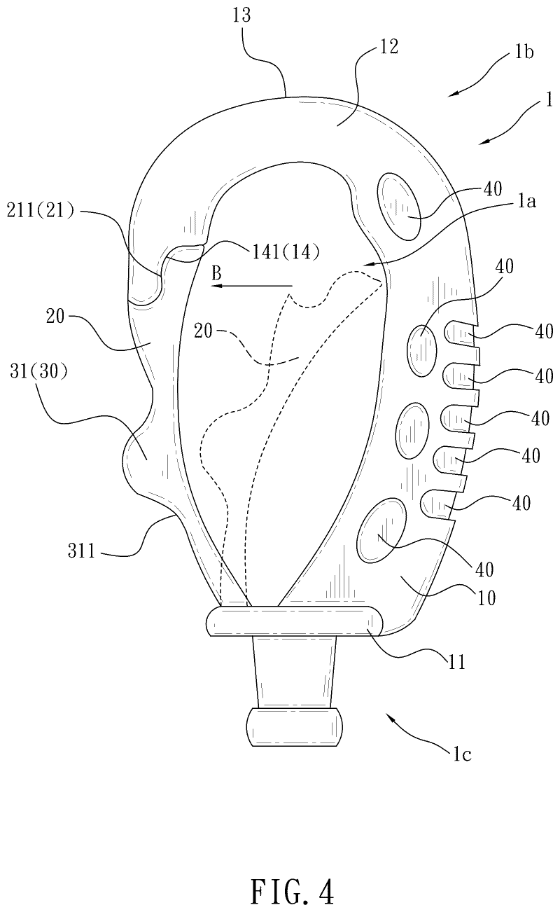

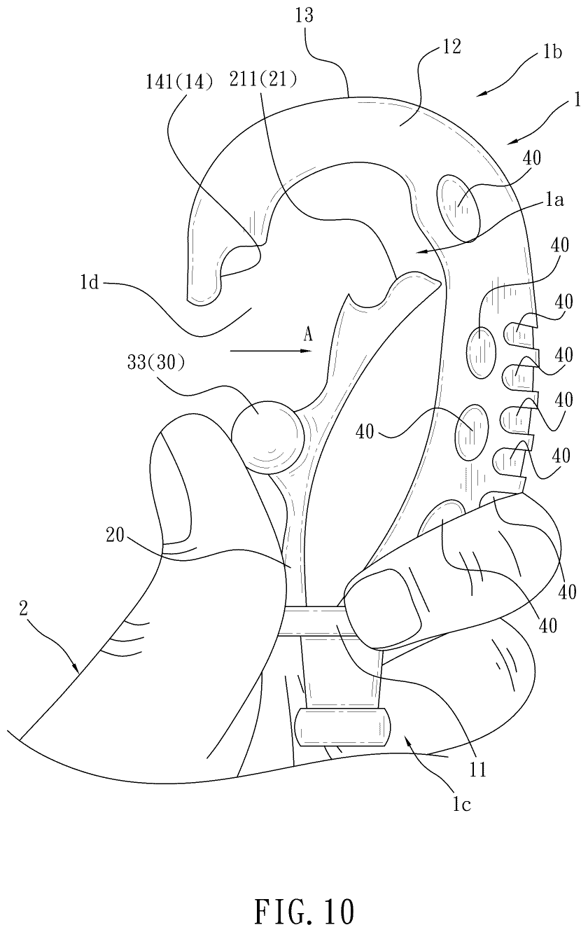

The moveable member 20 is provided with a front-end outer-side close surface 21 for being matched with and closed by a front-end inner-side close surface 14 of a curved portion 13 of the hook body 10. As shown in FIG. 2, the front-end outer-side close surface 21 is extending to reach the front-end inner-side close surface 14. The moveable member 20 is elastically moved with respect to the base 11 by using the base 11 as a pivot. Thus the moveable member 20 can be moved toward the looped area 1a (as the arrow A in FIG. 3 and the arrow A in FIG. 10 indicate) or moved away from the looped area 1a and turned back to its original position (as the arrow B in FIG. 4 indicates). Moreover, the moveable member 20 is integrally formed together with the elastic snap hook 1. By elastic deformation property of the structure made of synthetic resin, no common metal spring is required and installed. This lead to reduction in production cost. When the present product is applied to diving, users don't need to worry about a problem of rust and damages of the product caused by seawater erosion.

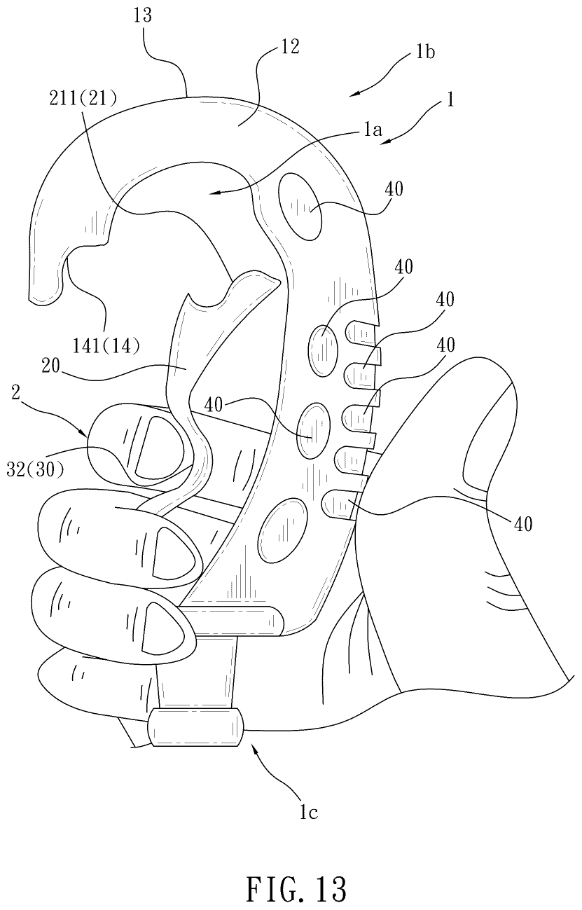

When a finger 2 is applying a force to the moveable member 20 and the moveable member 20 is moved toward the looped area 1a, the front-end outer-side close surface 21 is away from the front-end inner-side close surface 14 to be in a released state, as shown in FIG. 3, FIG. 10, and FIG. 13. In the released state, a hook-in space 1d is formed between the front-end outer-side close surface 21 and the front-end inner-side close surface 14, as shown in FIG. 3 and FIG. 10.

When the force applied to the moveable member 20 is released, the front-end outer-side close surface 21 is moved elastically away from the looped area 1a and turned back to its original position to be matched with the front-end inner-side close surface 14 and in a closed state, as shown in FIG. 4.

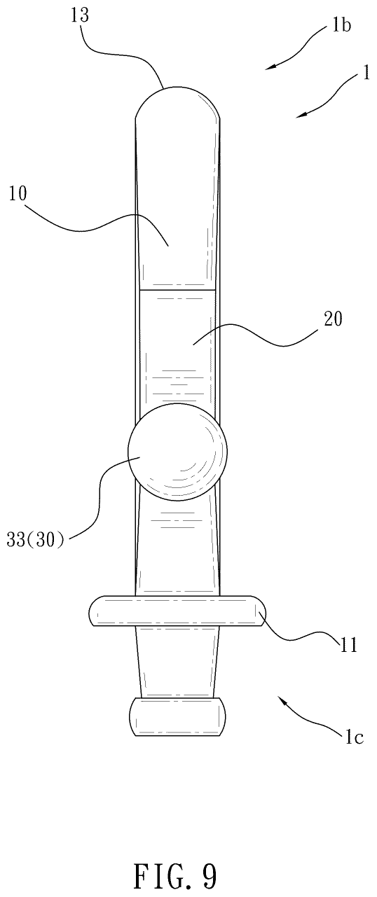

Refer to FIG. 1-13, a stopping portion 30 is disposed on a middle area of the moveable member 20 for stopping the finger 2 at a position between the stopping portion 30 and the base 11, as shown in FIG. 3, FIG. 10 and FIG. 13.

While in the closed state (as shown in FIG. 1 and FIG. 2), the finger 2 is firstly pressing on a position between the stopping portion 30 and the base 11, without moving toward the front end 1b, as shown in FIG. 3. At the moment, the finger 2 is applying a force to the stopping portion 30 so that the moveable member 20 is elastically moved toward the looped area 1a by using the base 11 as the pivot, as the arrow A in FIG. 3 indicates. Thereby the moveable member 20 is in the released state. During the released state, the finger 2 is stopped by the stopping portion 30 and unable to enter the hook-in space 1d, as shown in FIG. 3.

Refer to FIG. 1-4, the stopping portion 30 is a curved protrusion 31 projecting away from the looped area 1a, but not limited. A sliding ramp 311 is located between the curved protrusion 31 and the moveable member 20 for allowing users to put the finger 2 on.

Refer FIG. 12, the stopping portion 30 is a curved concave part 32 concave toward the looped area 1a for allowing users to put the finger 2 thereon, but not limited. The finger 2 is able to move from the moveable member 20 into the curved concave part 32, as shown in FIG. 13.

Refer to FIG. 8-10, the stopping portion 30 is a bead-like part 33 projecting away from the looped area 1a for allowing users to put the finger 2 thereon or limiting movement of the finger 2, but not limited. The finger 2 is further able to press the bead-like part 33 from the moveable member 20, as shown in FIG. 10.

According to different types of the stopping portion 30, there are multiple embodiments including the first embodiment (as shown in FIG. 3) in which the stopping portion 30 is the curved protrusion 31, the second embodiment (as shown in FIG. 13) in which the stopping portion 30 is the curved concave part 32, and the third embodiment (as shown in FIG. 10) in which the stopping portion 30 is the bead-like part 33. Thereby market competitiveness of the product is improved.

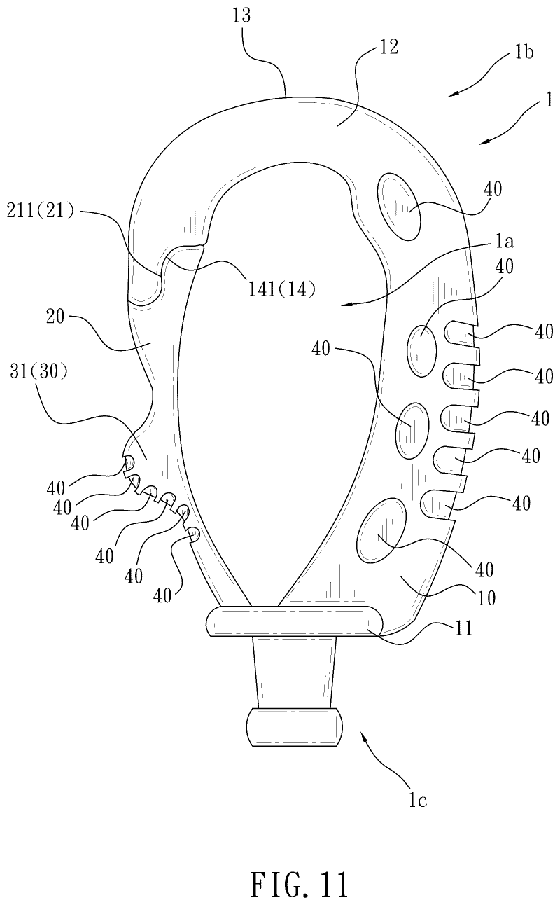

Refer to FIG. 11, the stopping portion 30 is further provided with a plurality of anti-slipping slots 40 for increasing a friction force while being touched by the user's finger 2, but not limited.

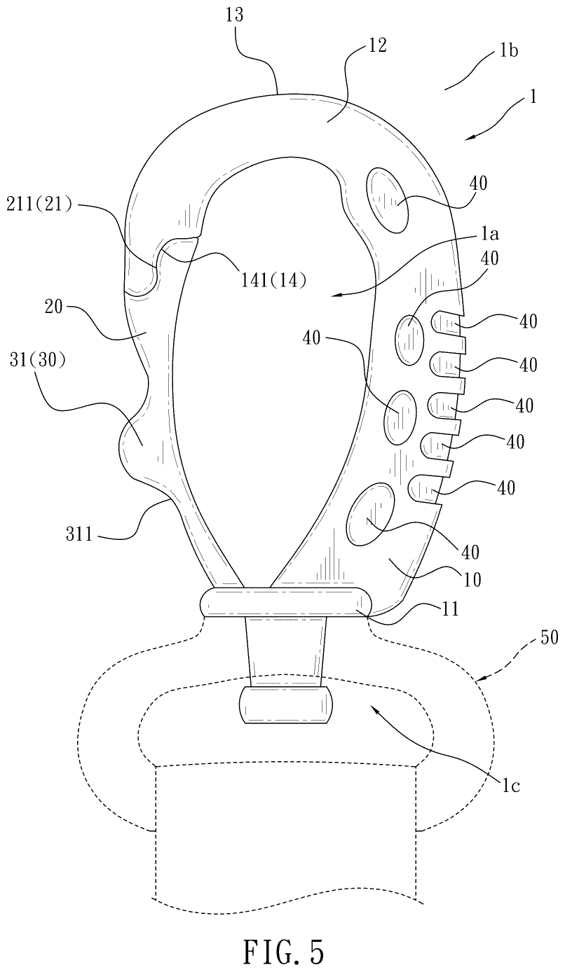

Refer to FIG. 5, a rotary ring 50 is disposed on the base 11 for connection with external parts such as webbing of shoulder bags and backpacks, but not limited. The rotary ring 50 is able to rotate on the base 11.

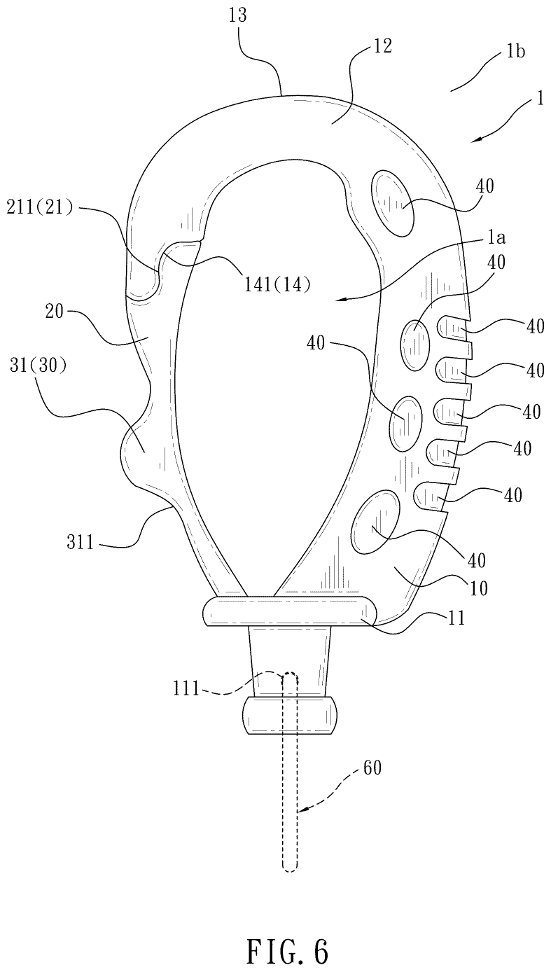

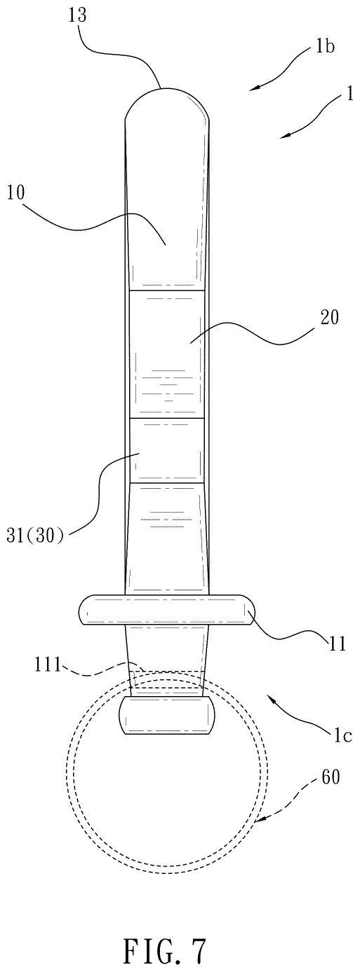

Refer to FIG. 6 and FIG. 7, the base 11 is further provided with a through hole 111, but not limited. A metal ring 60 is mounted to the through hole 111 and used for connection with external parts such as buckles of top-handle bags and bag-like objects.

Refer to FIG. 2 and FIG. 3, the front-end inner-side close surface 14 is further provided with a first closed portion 141, but not limited. The front-end outer-side close surface 21 is further provided with a second closed portion 211, but not limited. The first closed portion 141 and the second closed portion 211 are engaged with and closed by each other. The first closed portion 141 and the second closed portion 211 are step-like parts able to be engaged with and closed by each other.

Refer to FIG. 1, the hook body 10 is further provided with a plurality of anti-slipping slots 40 for increasing a friction force while being touched by the user's finger 2, but not limited.

Refer to FIG. 1, the elastic snap hook 1 is a hook used for diving specifically, but not limited. Thus the structure of the elastic snap hook 1 has a certain thickness and strength to prevent the elastic snap hook 1 in the sea from damages due to pressure.

Compared with the elastic snap hook available now, the present elastic snap hook 1 has the following advantages.
(1) The stopping portion 30 is disposed on the middle area of the moveable member 20 for stopping the finger 2 at a position between the stopping portion 30 and the base 11. While in the closed state, the finger 2 is firstly pressing on a position between the stopping portion 30 and the base 11, without being moved toward the front end 1b of the elastic snap hook 1. At the moment, the finger 2 is applying a force to the stopping portion 30 so that the moveable member 20 is elastically moved toward the looped area 1a of the elastic ring 1 by using the base 11 as the pivot to be in the released state. While in the released state, the finger 2 is stopped by the stopping portion 30 and unable to enter the hook-in space 1d of the elastic snap hook 1. Thereby the above design prevents negative emotions to users while using the product and further improves the market competitiveness of the product.
(2) The present elastic snap hook 1 will not allow the user's finger 2 to enter the hook-in space 1d. Thus the hook-in space 1d will not be occupied and objects are easy to be hooked into the hook-in space 1d. The elastic snap hook 1 is also easy to be taken out of the objects. Moreover, while being applied to diving, the present elastic ring 1 allows users to finish hooking operations in the sea quickly and easily. The users will not experience negative emotions while enjoying diving.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. An integrally formed elastic snap hook made from synthetic resin comprising: a hook body and a moveable member integrally formed with each other; and a looped area formed between the hook body and the moveable member; wherein the hook body includes a base and a hook portion extended from the base of the hook body; wherein the elastic snap hook is provided with a front end and a rear end based on the base; one end of the base is located at the rear end and the other end of the base is the front end which is extending toward a direction opposite to the rear end;
wherein the moveable member is provided with a front-end outer-side close surface for being matched with and closed by a front-end inner-side close surface of a curved portion of the hook body; the front-end outer-side close surface is extending to reach the front-end inner-side close surface;
wherein the moveable member is elastically moved with respect to the base by using the base as a pivot so that the moveable member is able to be moved toward the looped area or away from the looped area and turned back to its original position; wherein the front-end outer-side close surface is away from the front-end inner-side close surface to be in a released state when a finger is applying a force to the moveable member and the moveable member is moved toward the looped area; wherein while in the released state, a hook-in space is formed between the front-end outer-side close surface and the front-end inner-side close surface; wherein when the force applied to the moveable member is released, the front-end outer-side close surface is moved elastically away from the looped area and turned back to its original position to be matched with the front-end inner-side close surface and in a closed state; wherein the integrally formed elastic snap hook made from synthetic resin features on that a stopping portion is disposed on a middle area of the moveable member for stopping the finger between the stopping portion and the base;
wherein the finger is pressing on a position between the stopping portion and the base, without being moved toward the front end while in the closed state; now the finger is applying a force to the stopping portion so that the moveable member is elastically moved toward the looped area by using the base as the pivot and in the released state; while in the released state, the finger is stopped by the stopping portion and unable to enter the hook-in space.

2. The elastic snap hook as claimed in claim 1, wherein the stopping portion is a curved protrusion projecting away from the looped area and a sliding ramp is arranged between the curved protrusion and the moveable member.

3. The elastic snap hook as claimed in claim 1, wherein the stopping portion is a curved concave part concave toward the looped area; wherein the finger is able to move from the moveable member into the curved concave part.

4. The elastic snap hook as claimed in claim 1, wherein the stopping portion is a bead-like part projecting away from the looped area; wherein the finger is able to press the bead-like part from the moveable member.

5. The elastic snap hook as claimed in claim 1, wherein the stopping portion is provided with a plurality of anti-slipping slots.

6. The elastic snap hook as claimed in claim 1, wherein a rotary ring is disposed on the base.

7. The elastic snap hook as claimed in claim 1, wherein the base is further provided with a through hole and a metal ring is mounted to the through hole.

8. The elastic snap hook as claimed in claim 1, wherein the front-end inner-side close surface is further provided with a first closed portion and the front-end outer-side close surface is further provided with a second closed portion; wherein the first closed portion and the second closed portion are step-like parts able to be engaged with each other.
